(19) United States
(12) Patent Application Publication
(10) Pub. No.: US 2006/0104223 A1
(43) Pub. Date: May 18, 2006

(54) System and method to create synchronized environment for audio streams

(76) Inventors: Arnaud Glatron, Santa Clara, CA (US); Venkatesh Tumatikrishnan, Fremont, CA (US); Remy Zimmermann, Belmont, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/097,823

(22) Filed: Mar. 31, 2005

Related U.S. Application Data
(60) Provisional application No. 60/627,054, filed on Nov. 12, 2004.

(51) Int. Cl. H04B 3/20; H04J 3/06

(52) U.S. Cl. 370/286; 370/516

(57) ABSTRACT

A system and a process are disclosed for synchronizing asynchronous audio streams for synchronous consumption by an audio module. The system and the process receive a first audio stream and a second audio stream. The first audio stream serves as a baseline and is sent unaltered directly to the audio module. The second audio stream is split so that one split is output unaltered to a destination and the other split is input into a drift corrector. The drift corrector evaluates whether there is a drift between the first audio stream and the second audio stream. If there is drift, the second audio stream is appropriately adjusted to account for the drift. The drift-corrected second audio stream is then output to the audio module.

### CROSS REFERENCE TO RELATED APPLICATIONS

This application claims the benefit of U.S. provisional application 60/627,054 entitled “Transparent Audio Processing,” and filed Nov. 12, 2004, which is hereby incorporated by reference in its entirety; this application is related to U.S. patent application entitled “Audio Processing System,” filed Mar. 31, 2005, attorney docket number 19414-10194.

### BACKGROUND OF THE INVENTION

1. Field of the Invention

The present invention generally relates to the field of audio signal processing, and more particularly, to synchronizing two or more audio channels.

2. Description of the Related Art

Synchronization of two audio streams is known. In conventional systems, when two audio streams must be synchronized with each other, a common hardware clock is incorporated to ensure production and consumption of both audio streams at the same rate. However, as would be expected, such hardware-based solutions are costly because of increased design planning and integration that must be accounted for to ensure proper synchronization. Moreover, such solutions lack flexibility in the cases where the streams come from devices for which the hardware is not under control.

Conventional approaches to synchronization are also costly for system integrators seeking to allow ad hoc configurations and designs between audio inputs and outputs. Rather, conventional system integrators must prepare and design system configurations in advance by predicting what audio inputs and outputs will be introduced into the system. This unnecessarily increases system costs, particularly when certain audio inputs and outputs are little used or never used.

Therefore, there is a need for a system and process to input asynchronous audio streams and output them as a synchronized audio stream without a need for a hardware-based solution.

### SUMMARY OF THE INVENTION

The present invention includes a system and a method for synchronizing asynchronous audio streams for synchronous consumption by an audio module. The system includes a first channel for input of a first audio stream, a second channel for input of a second audio stream, an audio channel splitter (splitter), and a drift corrector. An input of the audio channel splitter couples the second channel and an output of the audio channel splitter couples an input of the drift corrector.

In one embodiment, the system receives the first audio stream and the second audio stream. The first audio stream serves as a baseline and is sent unaltered directly to the audio module. The audio channel splitter splits the second audio stream so that one split is output unaltered to a destination and the other split is input into the input of the drift corrector.

The drift corrector evaluates whether there is a drift between the first audio stream and the second audio stream. If there is drift, the second audio stream is appropriately adjusted to account for the drift. The drift-corrected second audio stream is then output from the drift corrector to the audio module, where it can be appropriately processed because it is synchronized with the first audio stream, for example, interleaving the streams for further audio processing.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 illustrates a logical architecture to synchronize two asynchronous audio streams for synchronous consumption by an audio module in accordance with one embodiment of the present invention.

FIG. 2 illustrates an example of a system synchronizing two asynchronous audio streams in an audio processing system in accordance with one embodiment of the present invention.

### DETAILED DESCRIPTION OF THE PREFERRED EMBODIMENTS

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

ARCHITECTURAL OVERVIEW

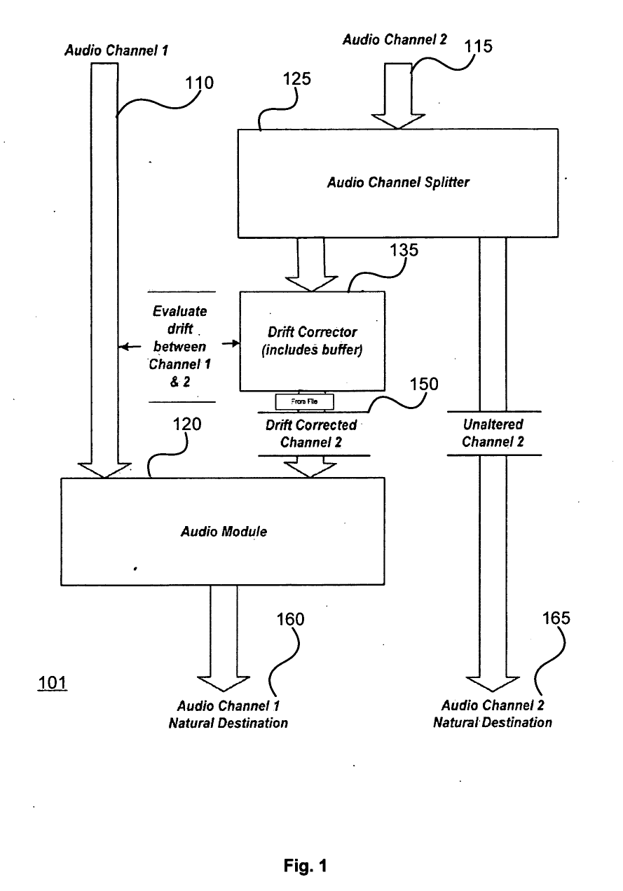

The present invention includes a system and a method for synchronizing asynchronous audio streams for synchronous consumption by an audio module. FIG. 1 illustrates a logical architecture of a system 101 to synchronize two asynchronous audio streams for synchronous consumption by an audio module in accordance with one embodiment of the present invention.

The system 101 includes inputs to receive a first audio channel 110 and a second audio channel 115, an audio channel splitter 125, and a drift corrector (including a buffer) 135. The first audio channel 110 is configured to input an audio module 120. The first audio channel 110 comprises a first audio stream that serves as a “baseline” to which a second audio stream will be synchronized. The audio module 120 is any audio processing configuration that inputs and processes synchronized audio streams before outputting them to their natural destination 160, i.e., the destination for the synchronized processed audio streams (e.g., a file, a transmission network, a device, an application). Examples of an audio module 120 may be an audio echo-canceling unit, a beam forming unit, or any module that consumes two streams in an interleaved manner while using a fixed frame size for input and output.

The second audio channel 115 comprises the second audio stream and is configured to input the audio channel splitter 125. The audio channel splitter (or splitter) 125 duplicates (or “splits”) the second audio stream to produce two separate outputs of the second audio stream. A first output sends the second audio stream unaltered to its natural destination 165. Examples of this natural destination 165 include a file, a transmission network, a device, or an application. The second output sends the second audio stream to the input of the drift corrector 135.

The drift corrector 135 is configured to evaluate the drift between the first audio stream and the second audio stream. The drift corrector 135 also includes a buffer that is configured to absorb the variations in frame size caused by pure drift correction in the case where audio module 120 is using fixed frame sizes. Once the drift is measured and evaluated, the drift corrector 135 adjusts the second audio stream so that the sampling rate of the second audio stream is the same as the first audio stream.

The drift corrected second audio stream is input into the audio module 120. The audio module 120 now has synchronized first and second audio streams. The audio module 120 may use these synchronized audio streams to process the audio for applications in which two such streams must be perfectly synchronized. As an example, the audio module 120 may process fixed size audio blocks in a synchronized interleaved manner (i.e., one packet from audio channel 1, one packet from audio channel 2, one packet from audio channel 1, one packet from audio channel 2, etc.) for applications such as audio echo cancellation (“AEC”) or beam forming. Once the audio stream is processed by audio module 120 it is output from the audio module 120 to its natural destination 160.

EXAMPLE—AUDIO ECHO CANCELLATION

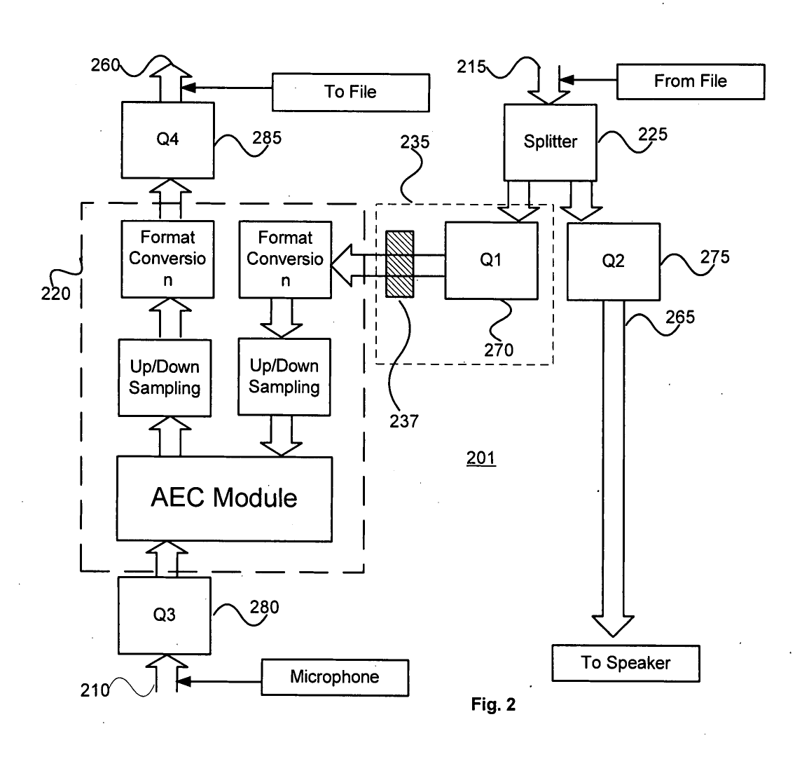

FIG. 2 illustrates an example of an audio system 201 that includes an audio echo cancellation logic, which requires synchronizing two asynchronous audio streams in accordance with one embodiment of the present invention. In one embodiment, because an audio echo cancellation function desires a perfect interleaving of two audio streams, the audio echo cancellation function must deal with various sources of drift. This drift may result from hardware devices such as from the use of two different devices clocked at different rates, or from software configurations, e.g., some systems may submit data for each stream at slightly different rates.

The audio system 201 illustrated includes a first audio input stream 210, a second audio input stream 215, audio echo cancellation logic 220, a splitter 225, a drift corrector 235, a first audio stream output 260, a second audio stream output 265, a first buffer (Q1) 270, a second buffer (Q2) 275, a third buffer (Q3) 280, and a fourth buffer (Q4) 285. An example of the first audio input stream 210 is a source such as a microphone. An example of the first audio output stream 260 is sink such as a write to file, e.g., save as .wav file. An example of the second audio input stream 215 is a source such as an audio file, e.g., a .wav or .rm (Real Media) or .avi file. An example of the second audio output stream 265 is a sink such as a speaker.

The first input audio stream 210 couples the third buffer 280, which couples the audio echo cancellation logic 220. The audio echo cancellation logic 220 couples the fourth buffer 285, which couples the first output audio stream 260. The second input audio stream 215 couples the channel splitter 225. The channel splitter 225 splits the second audio input stream 215 so that one stream goes directly to the second buffer 275 and out unaltered as the second audio output stream 265.

The copied second audio input stream 215 from the channel splitter 225 is fed into the first buffer 270 that may be configured as a part of the drift corrector 235. The drift corrector 235 includes a drift analysis engine 237 that evaluates the drift between the first audio input stream 210 and the second audio input stream 215 at this point. Thereafter, if appropriate, it adjusts a sampling rate of the second audio input stream 215 to match the sampling rate of the first audio input stream 210 so the two audio streams are synchronized at this point within the signal processing flow.

In operation, as with the system of FIG. 1, two input audio files 210, 215 enter the system. One, the first audio input stream 210, serves as a reference stream whose sampling rate the other audio input stream 215 is to be synchronized to. The second input audio stream 215 is split in the channel splitter 225 so that the second input audio stream 215 can be output unaltered 265 for its natural destination, e.g., a speaker. The other split of the second audio input stream 215 is sent to the drift corrector 235, which evaluates the drift between the first audio input stream 210 and the second audio input stream 215 and appropriately adjusts the sampling rate of the second audio input stream 215 so that it is synchronized with the first audio input stream 210. The synchronized audio input streams are consumed by the audio echo cancellation logic at the same rate, allowing for operations such as interleaving.

Note that because the first buffer 270, which is in (or associated with) the drift corrector 235 adds an offset to the second audio input stream 215, the second buffer 275, third buffer 280 and fourth buffer 285 are incorporated into the system to provide an optional stream delay on all streams. The optional stream delay may increase latency on all streams, but allows for the cancellation of the stream offset introduced by buffer 270 in case this matters for the behavior of audio system 201.

The present invention advantageously provides for a flexible audio processing architecture that allows for signal synchronization without the requirement for a unified hardware clock. A benefit of the present invention is increased design and operational flexibility, which increases overall system functionality without increasing design, operation, and other costs.

Upon reading this disclosure, those of skill in the art will appreciate still additional alternative structural and functional designs for a system and a process for synchronizing asynchronous audio streams for synchronous consumption by an audio module through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A system to synchronize asynchronous audio channels, the system comprising:
a first audio channel input configured to receive a first audio stream;
a second audio channel input configured to receive a second audio stream;
an audio splitter configured to split the second audio stream for output from a first output and a second output; and
a drift corrector configured to
receive the second audio stream from the first output;
evaluate whether there is a drift between the first audio stream and the second audio stream;
adjust the timing of the second audio stream in response to a presence of the drift; and
output a drift-corrected second audio stream.

2. The system of claim 1, wherein the first audio stream and the drift-corrected second audio stream are input into an audio module configured to process audio blocks.

3. The system of claim 3, wherein the audio module is configured to process audio blocks in a synchronized interleaved format.

4. The system of claim 2, wherein the audio module is an echo cancellation module.

5. The system of claim 2, wherein the audio module is configured to perform one of format conversion and up/down sampling.

6. The system of claim 1, wherein the second audio stream from the second output is transmitted unaltered to a destination.

7. The system of claim 1, further comprising at least one audio module configured to process one of: the first audio stream, the second audio stream, and the drift-corrected audio stream.

8. The system of claim 1, wherein the system is configured to receive an audio stream from one of: a microphone and an audio file.

9. The system of claim 1, wherein the system is configured to output an audio stream to one of: a transmission network, a device, a speaker, and an application.

10. The system of claim 1, further comprising a plurality of audio buffers, each buffer for providing stream delay to an audio stream.

11. A method to synchronize asynchronous audio channels, the method comprising:
receiving a first audio stream;
receiving a second audio stream;
splitting the second audio stream to generate a first output and a second output;
receiving the first output of the second audio stream;
evaluating whether there is a drift between the first audio stream and the second audio stream;
adjusting the timing of the second audio stream in response to a presence of the drift; and
outputting a drift-corrected second audio stream.

12. The method of claim 11, further comprising inputting the first audio stream and the drift-corrected second audio stream into an audio module configured to process audio blocks.

13. The method of claim 12, wherein the audio module is configured to process audio blocks in a synchronized interleaved format.

14. The method of claim 12, wherein the audio module is an echo cancellation module.

15. The method of claim 11, further comprising transmitting the second audio stream from the second output unaltered to a destination.

16. The method of claim 11, further comprising processing one of the first audio stream, the second audio stream, and the drift-corrected second audio stream.

17. The method of claim 11, further comprising receiving an audio stream from one of a microphone and an audio file.

18. The method of claim 11, further comprising outputting an audio stream to one of a transmission network, a device, a speaker, and an application.

19. The method of claim 11, further comprising performing one of format conversion and up/down sampling on an audio stream.

20. The method of claim 11, further comprising adjusting the timing of one of the first audio stream or the drift-corrected second audio stream.
